(19) United States
(12) Patent Application Publication
(10) Pub. No.: US 2010/0038346 A1
(43) Pub. Date: Feb. 18, 2010

(54) Auxiliary welding apparatus

(76) Inventors: Xiao Lin Wu, Tu-Cheng City (TW); Sung Lin Chen, Tu-Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/222,824

(22) Filed: Aug. 18, 2008

(51) Int. Cl. B23K 11/36

(52) U.S. Cl. 219/78.15

(57) ABSTRACT

An auxiliary welding apparatus adapted for separating central conductors of cables of a cable connector assembly, includes a holding base capable of fixing the cable connector assembly thereon. Two opposite sides of the holding base have two pivotal bearings facing each other. A rotation member is pivotally engaged between the two pivotal bearings and disposes a separating member fixed thereto. The separating member has a base portion fixed to the rotation member and a substantially comb-shaped separating portion extending from one side of the base portion for separating the central conductors of cables of the cable connector assembly to avoid the central conductors being welded with each other.

### BACKGROUND OF THE INVENTION

1. Field of the Invention

The present invention relates to an auxiliary welding apparatus, and more particularly to an auxiliary welding apparatus capable of facilitating cables to be welded to a PCB.

2. The Related Art

In the field of electronics, various cable connector assemblies are widely used. Please refer to FIG. 5, which shows a conventional cable connector assembly 9 for high definition multimedia interface (HDMI) including a location shelf 91 with two rows of cables 92 received within and a connector 93 with a printed circuit board (PCB) 94 attached on. The PCB 94 defines a plurality of welding points (no shown) on two opposite surfaces thereof. Central conductors 921 of the cables 92 are welded to the corresponding welding points of the PCB 94 by an automatic welding machine to achieve electrical connection between the cables 92 and the PCB 94.

Considering the cable connector assembly 9 having small size, so that intervals between two neighboring welding points of the PCB 94 is narrow as well. When the central conductors 921 of the cables 92 are welded to the welding points, two adjacent central conductors 921 would likely be welded with each other, which causes a short circuit and has a bad affect to the cable connector assembly 9. Therefore, it is desirable to have an auxiliary welding apparatus capable of separating the central conductors 921 of the cables 92 to overcome the problem encountered in the previous art.

### SUMMARY OF THE INVENTION

An object of the present invention is to provide an auxiliary welding apparatus adapted for separating central conductors of cables of a cable connector assembly. The auxiliary welding apparatus includes a holding base capable of fixing the cable connector assembly thereon. Two opposite sides of the holding base have two pivotal bearings facing each other. A rotation member is pivotally engaged between the two pivotal bearings and disposes a separating member fixed thereto. The separating member has a base portion fixed to the rotation member and a substantially comb-shaped separating portion extending from one side of the base portion for separating the central conductors of the cables of the cable connector assembly to avoid the central conductors being welding with each other when the cables are welded to a PCB of the cable connector assembly.

As described above, the rotation member and the separating members cooperate with each other to separate the central conductors of the cables of the cable connector assembly, which avoids every two of the neighboring central conductors being welded with each other. So that the cables can be exactly welded to corresponding welding points of the PCB and, a short circuit is therefore avoided.

### BRIEF DESCRIPTION OF THE DRAWINGS

The present invention will be apparent to those skilled in the art by reading the following description of a preferred embodiment thereof, with reference to the attached drawings, in which:

FIG. 1 is an assembled perspective view of an auxiliary welding apparatus according to the present invention;

FIG. 2 is an exploded view of the auxiliary welding apparatus;

FIG. 3 is an assembly view showing a separating member fixed to a rotation member of the auxiliary welding apparatus;

FIG. 4 is a perspective view showing the auxiliary welding apparatus worked for separating central conductors of cables of a cable connector assembly; and

FIG. 5 is a perspective view of the cable connector assembly shown in the FIG. 4.

### DETAILED DESCRIPTION OF THE PREFERRED EMBODIMENT

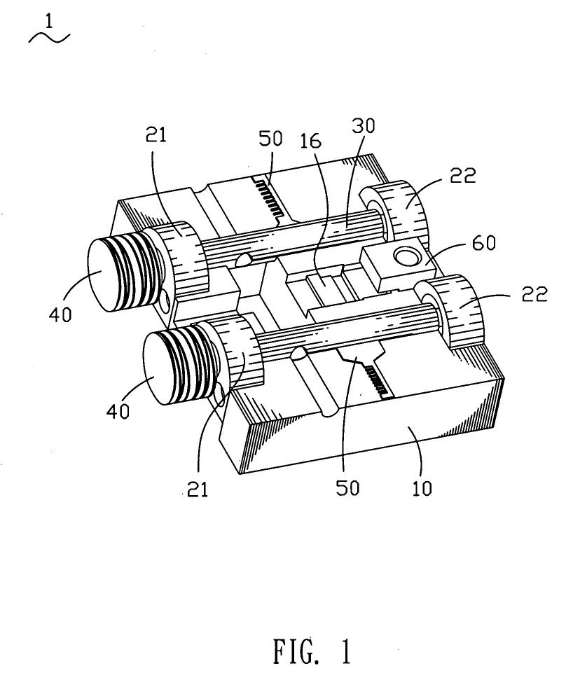

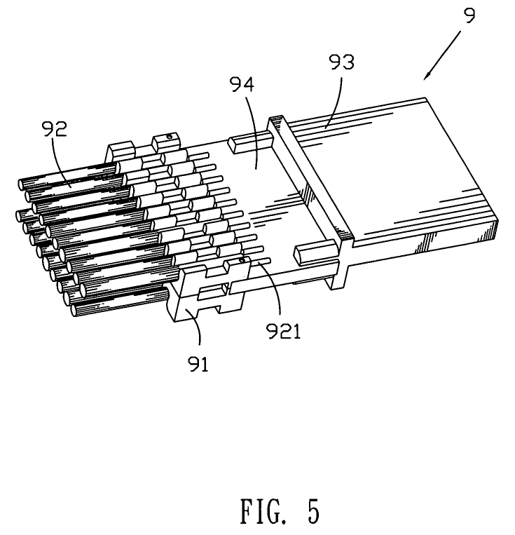

Please Refer to FIG. 1, an auxiliary welding apparatus 1 includes a holding base 10, plural pivotal bearings including two front pivotal bearings 21 and two rear pivotal bearings 22 fixed to two opposite sides of the holding base 10 respectively. A rotation member 30 is pivotally engaged between corresponding front and rear pivotal bearings 21, 22 and has a separating member 50 fixed thereto. Each of the front pivotal bearings 21 has a driver member 40 attached in front thereof for driving the rotation member 30 to rotate. The auxiliary welding apparatus 1 further includes a pressing member 60 to fix a cable connector assembly 9 (see FIG. 5) on the holding base 10.

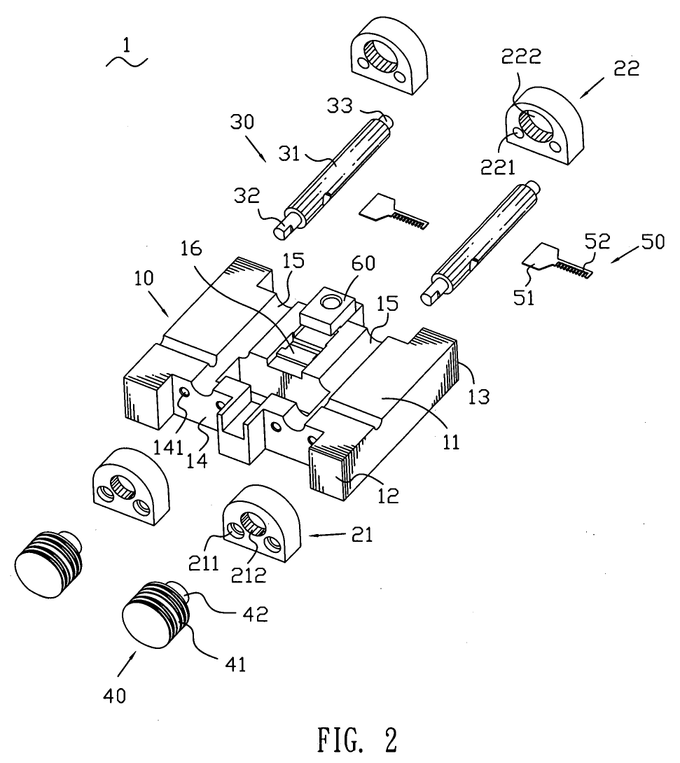

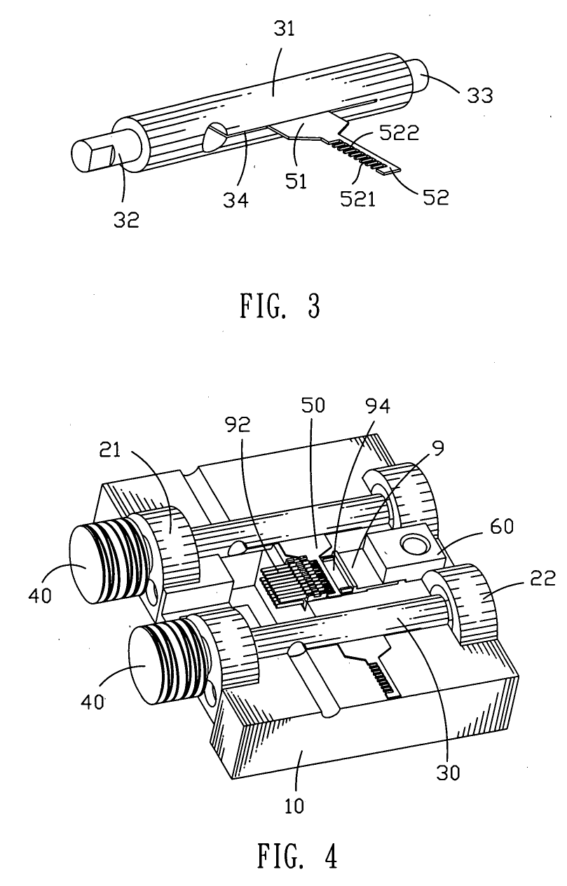

Referring to FIG. 2 and FIG. 3, the holding base 10 is of substantially cubic shape and has a top surface 11, a front surface 12 and a rear surface 13. Both of the front surface 12 and the rear surface 13 define two containing recesses 14 for receiving the pivotal bearings. A bottom of the containing recess 14 defines two lock holes 141 at an upper portion thereof. Two parallel fillisters 15 having arc-shaped bottoms are longitudinally defined on the top surface 11 and connected with the corresponding containing recesses 14. The top surface 11 defines a receiving cavity 16 between the two fillisters 15 for receiving the cable connector assembly 9. The pressing member 60 is fixed adjacent to the receiving cavity 16 for pressing the cable connector assembly 9.

The front pivotal bearings 21 and the rear pivotal bearings 22 are fixed in the corresponding containing recesses 14 of the holding base 10 by screws (not shown) screwed in fixing holes 211, 221 formed in the front and rear pivotal bearings 21, 22 to the lock holes 141 of the containing recesses 14. The front pivotal bearing 21 has a through-hole 212 and the rear pivotal bearing 22 defines a location hole 222.

The rotation member 30 has a cylindrical rotation axle 31 and a first and a second pivotal pillars 32, 33 protruding from two ends of the rotation axle 31 respectively. The rotation axle 31 defines a slot 34 extending along a center axis direction thereof and penetrating therethrough. The rotation member 30 is pivotally assembled between the front and rear pivotal bearings 21, 22 in such manner that parts of the rotation axle 31 are received in the fillister 15 and therefore the slot 34 is located on the same level as the top surface 11 of the holding base 10, the first pivotal pillar 32 passes through the through-hole 212 and the second pivotal pillar 33 is pivotally engaged to the location hole 222.

The driver member 40 has a rotation wheel 41 and a protruding pole 42 projecting from a rear portion of the rotation wheel 41. The protruding pole 42 defines a location trough (not shown) therein. The driver member 40 is installed to the front pivotal bearing 21 with the rotation wheel 41 disposed in front of the front pivotal bearing 21 and the protruding pole 42 received in the through-hole 212. In this case, the first pivotal pillar 32 is engaged in the location trough of the protruding pole 42, therefore, the driver member 40 can rotate the rotation member 30.

The separating member 50 has a thin slice of base portion 51 fixed in the slot 34 of the rotation member 30, and a substantially comb-shaped separating portion 52 extending from one side of the base portion 51. The separating portion 52 has a plurality of separating grooves 521 and combing teeth 522 formed between the neighboring separating grooves 521.

Referring to FIG. 4 and FIG. 5, which shows the auxiliary welding apparatus 1 used for separating central conductors 921 of cables 92 of the cable connector assembly 9. Firstly, the cable connector assembly 9 is placed in the receiving cavity 16 of the holding base 10 and being pressed by the pressing member 60. Next, one driver member 40 is driven to rotate one corresponding rotation member 30, then the rotation member 30 revolves the separating member 50 fixed thereon to separate one row of central conductors 921 of the cables 92. At the same time, the central conductors 921 are received in corresponding separating grooves 521 and separated by the combing teeth 522. So, the row of central conductors 921 of the cables 92 can be accurately welded to corresponding welding points of the PCB 94 but not be welded with each other.

The mentioned driver member 40 works again to depart the separating member 50 from the cable connector assembly 9. Then reverse the cable connector assembly 9 to expose the other row of cables 92 and repeat the above mentioned steps to drive the other driver member 40 to finish the corresponding separating member 50 dividing the other row of central conductors 921. Thus, the central conductors 921 are all completely soldered to the PCB 94 without being welded together.

As described above, the rotation member 30 and the separating members 50 cooperate with each other to separate the central conductors 921 of the cables 92 of the cable connector assembly 9, which avoids every two of the neighboring central conductors 921 being welded together. So that the central conductors 921 can be exactly welded to the corresponding welding points of the PCB 94, and a short circuit is therefore avoided.

What is claimed is:

1. An auxiliary welding apparatus adapted for separating central conductors of cables of a cable connector assembly, comprising:
a holding base capable of fixing the cable connector assembly thereon, two opposite sides of the holding base having two pivotal bearings facing each other;
a rotation member pivotally engaged between the two pivotal bearings; and
a separating member having a base portion fixed to the rotation member and a substantially comb-shaped separating portion extending from one side of the base portion for separating the central conductors of the cables.

2. The auxiliary welding apparatus as claimed in claim 1, further comprising a driver member which includes a rotation wheel and is attached to one of the pivotal bearings defining a through-hole therein, and a protruding pole projecting from the rotation wheel and inserted into the through-hole, the protruding pole is hollowed for pivotally engaging with one end of the rotation member.

3. The auxiliary welding apparatus as claimed in claim 1, wherein the rotation member defines a slot extending along an axis direction thereof for fixing the base portion of the separating member therein.

4. The auxiliary welding apparatus as claimed in claim 1, wherein the holding base defines two containing recesses at the two opposite sides thereof for receiving the corresponding pivotal bearings and a fillister located at a top surface of the holding base and connected to the two containing recesses, the fillister has a substantially arc-shaped bottom for receiving parts of the rotation member.
